(19) United States
(12) Patent Application Publication
(10) Pub. No.: US 2011/0074228 A1
(43) Pub. Date: Mar. 31, 2011

(54) VIBRATION MOTOR

(75) Inventors: Yong-Jin KIM, Suwon-si (KR); Hwa-Young Oh, Seoul (KR); Jee-Sung Lee, Suwon-si (KR); Seok-Jun Park, Suwon-si (KR); Je-Hyun Bang, Suwon-si (KR); Kwang-Hyung Lee, Suwon-si (KR); Kyoung-Ho Lee, Suwon-si (KR); Jun-Kun Choi, Suwon-si (KR); Ki-Suk Woo, Seoul (KR)

(73) Assignee: SAMSUNG ELECTRO-MECHANICS CO., LTD.

(21) Appl. No.: 12/760,071

(22) Filed: Apr. 14, 2010

(30) Foreign Application Priority Data
Sep. 29, 2009 (KR) 10-2009-0092427

(51) Int. Cl. H02K 33/00

(52) U.S. Cl. 310/29

(57) ABSTRACT

A vibration motor is disclosed. In accordance with an embodiment of the present invention, the vibration motor includes a cylinder-shaped coil unit, a vibrator, which is inserted into the coil unit and includes a magnet that forms an asymmetric magnetic field in a vibration direction, and an elastic body, which elastically supports the vibrator. Thus, the vibration motor can have a nonlinear characteristic, and thus a frequency bandwidth in which a resonance occurs can be expanded.

### CROSS-REFERENCE TO RELATED APPLICATIONS

This application claims the benefit of Korean Patent Application No. 10-2009-0092427, filed with the Korean Intellectual Property Office on Sep. 29, 2009, the disclosure of which is incorporated herein by reference in its entirety.

### BACKGROUND

1. Technical Field

The present invention is related to a vibration motor.

2. Description of the Related Art

A vibration motor is a part that converts electrical energy into mechanical vibrations by using the principle of generating electromagnetic forces, and is commonly installed in a mobile phone to generate a soundless vibrating alert. With the rapid expansion of mobile phone markets and increased functionalities added to the mobile phone, mobile phone parts are increasingly required to be smaller and better. As a result, there has been an increased demand for the development of a new structure of vibration motor that can overcome the shortcomings of conventional vibration motors and effectively improve the quality.

As mobile phones having a bigger LCD screen have become popular for the past few years, there have been an increasing number of mobile phones adopting a touch-screen method, by which vibration is generated when the screen is touched. Touch-screens particularly require that the vibration motor has a greater durability due to a greater frequency of generating vibration in response to the touch compared to the vibration bell for incoming calls and that the vibration has a faster response to the touch made on the touch screen, in order to provide a user a greater satisfaction from sensing the vibration when touching the touch screen.

Commonly used to overcome the drawbacks of shorter life time and slower responsiveness in the vibrating functionality of touchscreen phones is a linear vibration motor, which does not use the principle of rotating of a motor but uses an electromagnetic force having a predetermined resonant frequency to generate vibrations by use of a spring installed in the vibration motor and a mass coupled to the spring. Here, the electromagnetic force is generated through an interactive reaction between a magnet, which is placed on the moving mass, and a direct or alternating current having a particular frequency flowing through a coil, which is placed on a stationary part.

In the conventional vibration motor, however, it is difficult to generate resonance because a frequency band in which the resonance occurs is very narrow. In other words, the linear vibration motor has a weaker vibration force if there is a difference between the resonant frequency (fn) and an input frequency.

### SUMMARY

The present invention provides a vibration motor that can increase the amplitude of vibrations in a wider frequency band.

An aspect of the present invention provides a linear vibrator that includes a cylinder-shaped coil unit, a vibrator, which is inserted into the coil unit and includes a magnet that forms an asymmetric magnetic field in a vibration direction, and an elastic body, which elastically supports the vibrator.

The magnet can include a core and a pair of magnetic members, in which the pair of magnetic members are coupled to either end of the core and have different magnetic forces from each other.

The magnet can include a core and a pair of magnetic members, in which the pair of magnetic members are coupled to either end of the core and have different diameters from each other.

The magnet can include a core and a pair of magnetic members, in which the pair of magnetic members are coupled to either end of the core and have different lengths from each other.

The core of the magnet can be disposed eccentrically in the coil unit.

The vibrator can further include a weight, which is coupled to the magnet.

The vibration motor can further include a base having a bobbin formed thereon, and the coil unit can be coupled to the bobbin.

The vibration motor can further include a base having a pair of supporting parts formed thereon, in which the pair of supporting parts face each other. Here, a pair of the elastic bodies can be respectively interposed between the vibrator and the pair of supporting parts.

Another aspect of the present invention provides a vibration motor that includes a cylinder-shaped coil unit, a vibrator, which includes a magnet inserted into the coil unit, and a pair of elastic bodies, in which each elastic body elastically supports either end of the vibrator and has a different elastic characteristic.

The pair of elastic bodies can have different moduli of elasticity from each other.

The pair of elastic bodies can have different shapes from each other.

The pair of elastic bodies can have different displacements of vibration from each other.

The vibration motor can further include a base accommodating the vibrator. Here, the elastic body can be a leaf spring including a frame and a plurality of elastic members, in which the frame is coupled to the base or the vibrator and the plurality of elastic members are extended from an inner side of the frame.

The vibrator can further include a weight, which is coupled to the magnet.

The vibration motor can further include a base having a pair of supporting parts formed thereon, in which the pair of supporting parts face each other. Here, the pair of elastic bodies can be respectively interposed between the vibrator and the pair of supporting parts.

The vibration motor can further include a base having a bobbin formed thereon, and the coil unit can be coupled to the bobbin.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded perspective view of a vibration motor in accordance with an embodiment of the present invention.

FIG. 2 is a perspective view illustrating assembling of a vibrator in a vibration motor in accordance with an embodiment of the present invention.

FIGS. 3 to 5 illustrate different magnets that can be used in a vibration motor in accordance with an embodiment of the present invention.

FIG. 6 is a graph illustrating a frequency bandwidth of a conventional vibration motor.

FIG. 7 is a graph illustrating a frequency bandwidth of a vibration motor in accordance with an embodiment of the present invention.

FIG. 8 is a plan view of a vibration motor in accordance with another embodiment of the present invention.

### DETAILED DESCRIPTION

The features and advantages of this invention will become apparent through the below drawings and description.

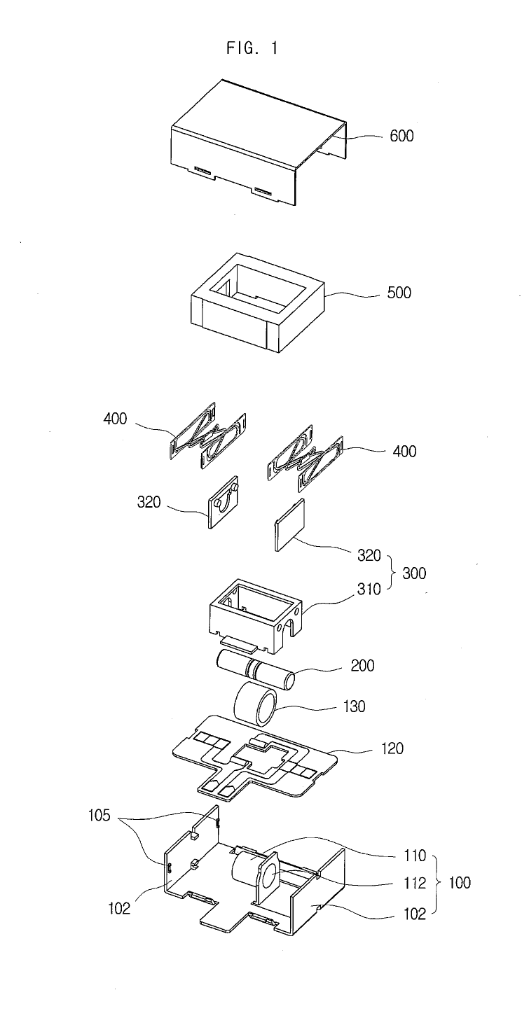

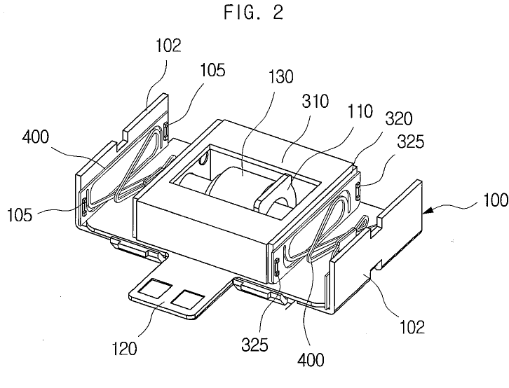

FIG. 1 is an exploded perspective view of a vibration motor in accordance with an embodiment of the present invention, and FIG. 2 is a perspective view illustrating assembling of a vibrator in a vibration motor in accordance with an embodiment of the present invention.

A vibration motor in accordance with an embodiment of the present invention includes a coil unit 130, a vibrator, which has a magnet 200, and an elastic body 400. The vibration motor can also include a base 100, and the vibrator can also include a weight 500.

The base 100, in which the components of the vibration motor are housed, has a space that supports the components of the vibration motor. In this embodiment, a bobbin 110 is disposed at the center of the base 100, and a pair of supporting parts 102 facing each other are formed on either end of the base 100.

Specifically, the bobbin 110 is a part that can support the coil unit 130 and can have a cylindrical shape having a hollow part 112 formed therein. Also, the pair of supporting parts 102 can be formed in the shape of a pair of partition walls facing each other and formed on either end of the base 100. Meanwhile, a case 600 covers the base 100 and forms the exterior of the vibration motor.

The coil unit 130 generates an electromagnetic force that is needed to generate vibrations and has a cylindrical shape having a hollow part formed therein with a coil being wound on the cylindrical shape. By inserting the bobbin 110 into the hollow part of the coil unit 130, the coil unit 130 can be installed on the base 102.

A substrate 120 is a part that provides electrical connection to the coil unit 130. A circuit pattern can be formed on one surface of the substrate 120. The substrate 120 is installed on the base 102, and the bobbin 110 can be exposed toward the upper side of the substrate 120 through an opening formed at the center of the substrate 120.

The vibrator is a part that reciprocates in the base 100 and can be vibrated by the electromagnetic force of the coil unit 130. The vibrator of this embodiment includes a magnet 200 and a weight 500.

The magnet 200 is a part that receives force from the electromagnetic force of the coil unit 130, and the magnet 200 of the present embodiment forms an asymmetric magnetic field in the direction of vibration.

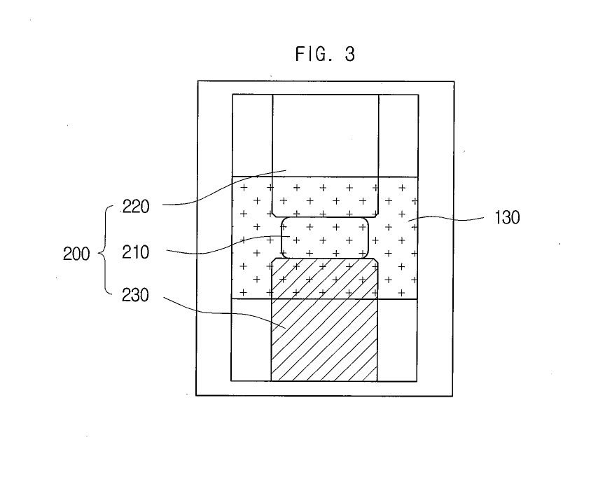

FIGS. 3 to 5 illustrate different magnets that can be used in a vibration motor in accordance with an embodiment of the present invention.

The magnet 200 of this embodiment has a cylindrical shape extended lengthwise. By being inserted into the hollow part of the bobbin 110, the magnet 200 can move horizontally in the hollow part of the bobbin 110.

Particularly, the magnet 200 of the present embodiment forms an asymmetric magnetic field in the direction of vibration. That is, magnetic fields having different shapes or different sizes are formed on either lengthwise side of the magnet 200.

For this, as illustrated in FIG. 3, the magnet 200 is constituted by a magnetic core 210 and a pair of magnetic members 220 and 230, which are coupled to either end of the core 210 in such a way that same magnetic-poles of the magnetic members 220 and 230 can face either end of the core 210. The pair of magnetic members 220 and 230 have different magnetic forces from each other.

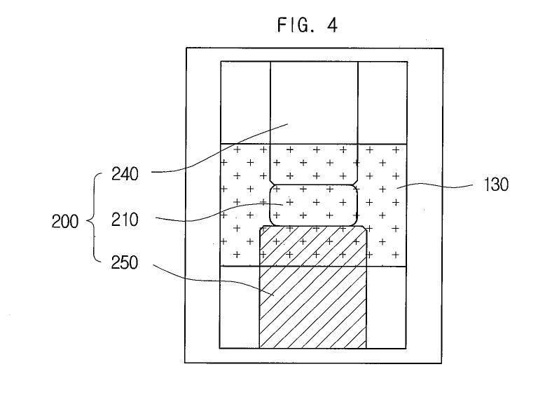

Also, as illustrated in FIG. 4, the magnet 200 can be constituted by the core 210 and a pair of magnetic members 240 and 250, which are coupled to either end of the core 210 and have different diameters from each other.

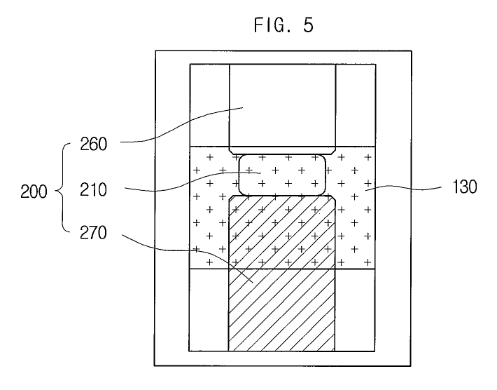

Also, as illustrated in FIG. 5, the magnet 200 can be constituted by the core 210 and a pair of magnetic members 260 and 270, which are coupled to either end of the core 210 and have different lengths from each other. That is, the core 210 of the magnet 200 can be disposed eccentrically in the coil unit 130.

As illustrated in FIGS. 3 to 5, by forming an asymmetric magnetic field in the direction of vibration of the magnet 200, an electromagnetic force received by the magnet 200 from the coil unit 130 can vary according to the moving direction of the magnet 200. As a result, the exciting force of the vibration motor can have a nonlinear characteristic, and thus a frequency bandwidth in which a resonance occurs can be expanded.

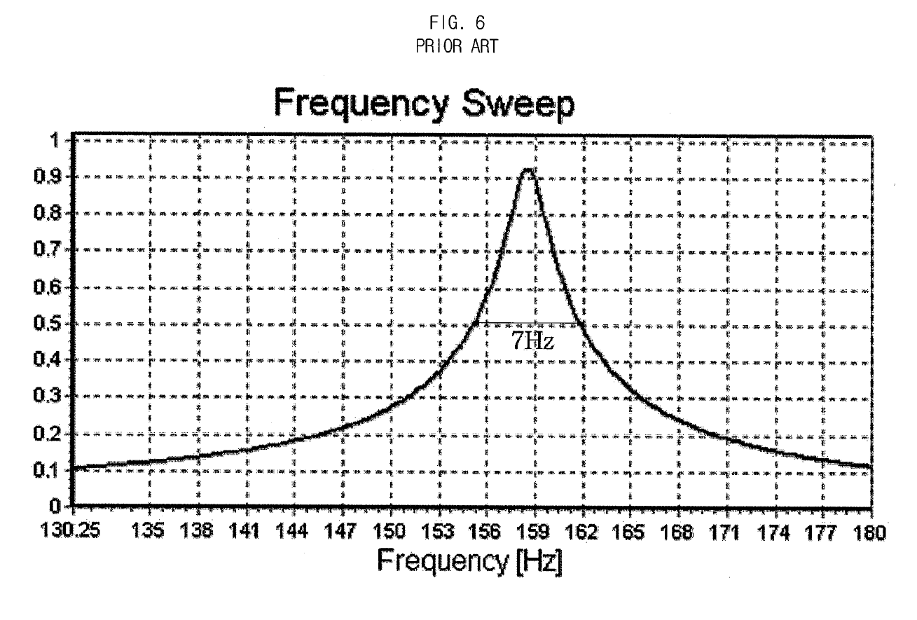

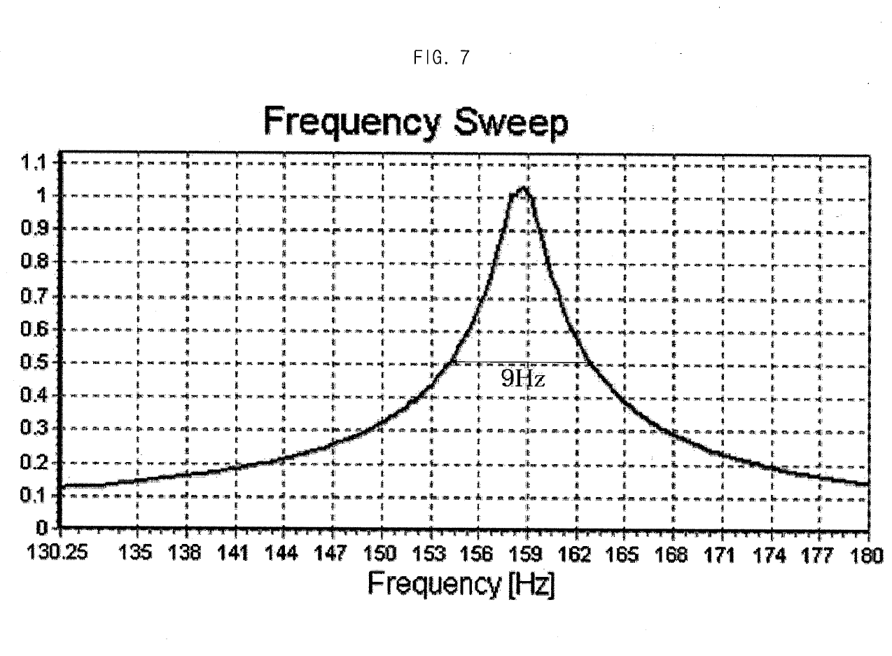

FIG. 6 is a graph illustrating a frequency bandwidth of a conventional vibration motor, and FIG. 7 is a graph illustrating a frequency bandwidth of a vibration motor in accordance with an embodiment of the present invention.

As illustrated in FIGS. 6 and 7, the nonlinear characteristic of an electromagnetic force, i.e., the exciting force, can expand the bandwidth of frequencies in which a resonance occurs.

Meanwhile, as illustrated in FIG. 2, a yoke 300 can prevent the leakage of magnetic flux of the magnet 200 and converge the magnetic flux. Particularly, the yoke 300 includes a cover yoke 310 and a back yoke 320. The cover yoke 310 can be shaped as a rectangular cuboid generally surrounding the magnet 200. The back yoke 320 can be coupled to both ends of the magnet 200 and the cover yoke 310.

The weight 500 is a rectangular cuboid generally surrounding the yoke 300. The weight 500 is installed outside the magnet 200 and the yoke 300 and can generate strong vibrations through repetitive horizontal movement with the magnet 200.

The elastic body 400 is a part that elastically supports the vibrator in such a way that the vibrator can resonate. For this, the elastic body 400 is interposed between the base 100 and the vibrator.

As illustrated in FIG. 2, the elastic body 400 of this embodiment is a leaf spring that is interposed between the supporting part 102 of the base 100 and either end of the vibrator, respectively. Moreover, the elastic body 400 is a leaf spring that has a frame having a through-hole, into which a protruding part 105 of the base 100 or a protruding part 325 of the vibrator is inserted, formed therein and an elastic member extended from the inner side of the frame. By inserting the protruding parts 105 and 325 into the through-hole to dispose the leaf spring, the leaf spring can be correctly assembled.

Hereinafter, a vibration motor in accordance with another embodiment of the present invention will be described.

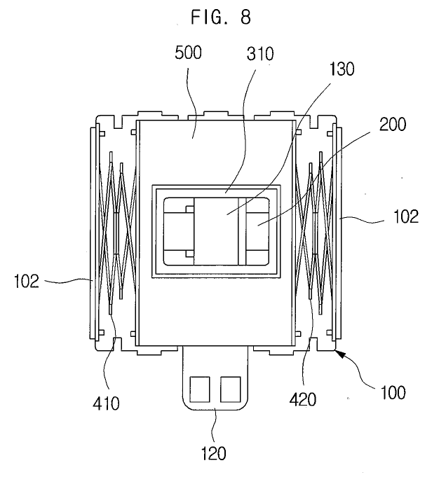

FIG. 8 is a plan view of a vibration motor in accordance with another embodiment of the present invention.

Compared to the previously described embodiment of the present invention, a vibration motor in accordance with the present embodiment of the present invention is different in that the pair of elastic members 410 and 420, each of which is interposed between the base 100 and either end of the vibrator, have different elastic characteristics from each other. Here, the magnet 200 can be formed asymmetrically, like the previously described embodiment of the present invention, or formed symmetrically, like the magnet in accordance with the related art. Thus, identical description of the previously described embodiment or the related art will be omitted, and the pair of elastic members 410 and 420 will be mainly described herein.

The elastic bodies 410 and 420 are parts that elastically support the vibrator in such a way that the vibrator can resonate. For this, the elastic bodies 410 and 420 are respectively interposed between the base 100 and either side of the vibrator. Particularly, the vibration motor of the present embodiment includes the pair of elastic members 410 and 420, which have different elastic characteristics from each other.

For this, the pair of elastic members 410 and 420 can have different elastic moduli from each other. Specifically, each elastic member can be made of a material having a different modulus of elasticity.

Also, the pair of elastic members 410 and 420 can have different shapes from each other. As a result, the pair of elastic members 410 and 420 can have different elastic forces from each other while they are deformed by a same displacement.

Furthermore, the pair of elastic members 410 and 420 can have different displacements of vibration from each other. By setting the initial displacement differently or setting the maximum displacement differently, the elastic members 410 and 420 can have different elastic characteristics from each other even though they are made of a same elastic material.

Therefore, an asymmetric elastic force is formed on both sides of the vibrator so that an elastic force received by the vibrator from the elastic members 410 and 420 can vary according to the moving direction of the vibrator. As a result, the elastic force can have a nonlinear characteristic, and thus a frequency bandwidth in which a resonance occurs can be expanded.

While the spirit of the present invention has been described in detail with reference to particular embodiments, the embodiments are for illustrative purposes only and shall not limit the present invention. It is to be appreciated that those skilled in the art can change or modify the embodiments without departing from the scope and spirit of the present invention.

What is claimed is:

1. A vibration motor comprising:
a cylinder-shaped coil unit;
a vibrator inserted into the coil unit, and comprising a magnet configured to form an asymmetric magnetic field in a vibration direction; and
an elastic body elastically supporting the vibrator.

2. The vibration motor of claim 1, wherein the magnet comprises a core and a pair of magnetic members, the pair of magnetic members coupled to either end of the core and having different magnetic forces from each other.

3. The vibration motor of claim 1, wherein the magnet comprises a core and a pair of magnetic members, the pair of magnetic members coupled to either end of the core and having different diameters from each other.

4. The vibration motor of claim 1, wherein the magnet comprises a core and a pair of magnetic members, the pair of magnetic members coupled to either end of the core and having different lengths from each other.

5. The vibration motor of claim 1, wherein the core of the magnet is disposed eccentrically in the coil unit.

6. The vibration motor of claim 1, wherein the vibrator further comprises a weight coupled to the magnet.

7. The vibration motor of claim 1, further comprising a base having a bobbin formed thereon,
wherein the coil unit is coupled to the bobbin.

8. The vibration motor of claim 1, further comprising a base having a pair of supporting parts formed thereon, the pair of supporting parts facing each other,
wherein a pair of the elastic bodies are respectively interposed between the vibrator and the pair of supporting parts.

9. A vibration motor comprising:
a cylinder-shaped coil unit;
a vibrator comprising a magnet inserted into the coil unit; and
a pair of elastic bodies, each elastic body elastically supporting either end of the vibrator and having a different elastic characteristic.

10. The vibration motor of claim 9, wherein the pair of elastic bodies have different moduli of elasticity from each other.

11. The vibration motor of claim 9, wherein the pair of elastic bodies have different shapes from each other.

12. The vibration motor of claim 9, wherein the pair of elastic bodies have different displacements of vibration from each other.

13. The vibration motor of claim 9, further comprising a base accommodating the vibrator,
wherein the elastic body is a leaf spring comprising a frame and a plurality of elastic members, the frame coupled to the base or the vibrator, the plurality of elastic members extended from an inner side of the frame.

14. The vibration motor of claim 9, wherein the vibrator further comprises a weight coupled to the magnet.

15. The vibration motor of claim 9, further comprising a base having a pair of supporting parts formed thereon, the pair of supporting parts facing each other,
wherein the pair of elastic bodies are respectively interposed between the vibrator and the pair of supporting parts.

16. The vibration motor of claim 9, further comprising a base having a bobbin formed thereon,
wherein the coil unit is coupled to the bobbin.
